(19) United States
(12) Patent Application Publication
(10) Pub. No.: US 2015/0263652 A1
(43) Pub. Date: Sep. 17, 2015

(54) SYNCHRONIZING METHOD OF FAN ROTATIONAL SPEED

(71) Applicant: ASIA VITAL COMPONENTS CO., LTD., New Taipei City (TW)

(72) Inventors: Sung-Hsien Sun, New Taipei City (TW); Dong-Qi Tian, New Taipei City (CN)

(73) Assignee: ASIA VITAL COMPONENTS CO., LTD., New Taipei City (TW)

(21) Appl. No.: 14/205,302

(22) Filed: Mar. 11, 2014

(51) Int. Cl. H02P 5/50

(52) U.S. Cl. CPC H02P 5/50

(57) ABSTRACT

A synchronizing method of fan rotational speed includes steps of: using a first Hall sensor to detect pulse period width generated by the rotational speed of the first fan and converting the pulse period width into a first pulse signal and transmitting the first pulse signal to a microprocessor; using a second Hall sensor to detect pulse period width generated by the rotational speed of the second fan and converting the pulse period width into a second pulse signal and transmitting the second pulse signal to the microprocessor; using the microprocessor to compare the first and second pulse signals corresponding to the pulse period widths of the rotational speeds of the first and second fans; and the microprocessor generating a pulse modulation signal to the second fan so as to control the rotational speed of the second fan to be equal to the rotational speed of the first fan.

### BACKGROUND OF THE INVENTION

1. Field of the Invention

The present invention relates generally to a synchronizing method of fan rotational speed, and more particularly to a synchronizing method of fan rotational speed, which can synchronize the rotational speed and lower the noise made in operation of the fan.

2. Description of the Related Art

Along with the advance of sciences and technologies, the reliance of peoples on various electronic apparatuses has more and more increased. In the design of the electronic products (such as computers and laptops) on the current market, there is a trend to develop lighter, thinner and smaller electronic products with higher processing speed and multiple functions in accordance with the requirements for easy carriage and utility in modern life.

In order to enhance the performance of the cooling fan, in the conventional fan control, the system manufacturers often such design the electronic products that when the temperature of the electronic products rises, the rotational speed of the fan is increased to enhance the heat dissipation effect. In a typical method, the temperature of an electronic product is detected. According to the detected temperature, a fan controller controls the rotational speed of the fan. In general, the rotational speed of the fan can be controlled by means of pulse-width modulation (PWM) duty ratio or voltage output. In some cases, one single fan may fail to provide sufficient air volume. To overcome this problem, two or more fans are often serially connected and assembled with each other and co-used to provide sufficient air volume.

Moreover, in the same input condition, when the series fan operates, the rotational speeds of the two fans are still often different from each other. In this case, the two fans will interfere with each other to affect the ambient flow field distribution. Therefore, the rotational speeds of the two fans cannot be synchronized and the two fans will interfere with each other to make noise. The frequency spectrum of the noise will be increased and cannot be eliminated. In addition, the asynchronism of the operation of the fans will lead to deterioration of the operation efficiency of the fans. According to the above, the conventional cooling fan has the following shortcomings:

1. The rotational speed cannot be synchronized.

2. The noise cannot be lowered.

### SUMMARY OF THE INVENTION

It is therefore a primary object of the present invention to provide a synchronizing method of fan rotational speed, which can control the fans to synchronously operate by equal rotational speed.

It is a further object of the present invention to provide the above synchronizing method of fan rotational speed, which can lower the noise made in operation of the fans.

It is still a further object of the present invention to provide the above synchronizing method of fan rotational speed, which can enhance the operation efficiency of the fans.

To achieve the above and other objects, the synchronizing method of fan rotational speed of the present invention is applied to a first fan and a second fan mated with each other. The synchronizing method of fan rotational speed includes steps of:

using a first Hall sensor to detect pulse period width generated by the rotational speed of the first fan and converting the pulse period width into a first pulse signal and transmitting the first pulse signal to a microprocessor;

using a second Hall sensor to detect pulse period width generated by the rotational speed of the second fan and converting the pulse period width into a second pulse signal and transmitting the second pulse signal to the microprocessor;

the microprocessor comparing the first and second pulse signals corresponding to the pulse period widths of the rotational speeds of the first and second fans;

the microprocessor generating a pulse modulation signal to the second fan according to the difference between the first and second pulse signals; and

the microprocessor controlling the rotational speed of the second fan to be equal to the rotational speed of the first fan by means of the pulse modulation signal.

By means of the synchronizing method of fan rotational speed of the present invention, the fans can be controlled to synchronously operate by equal rotational speed. In addition, the noise made in operation of the fans is lowered.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a block diagram of a preferred embodiment of the present invention; and

FIG. 2 is a flow chart of a preferred embodiment of the present invention.

### DETAILED DESCRIPTION OF THE PREFERRED EMBODIMENTS

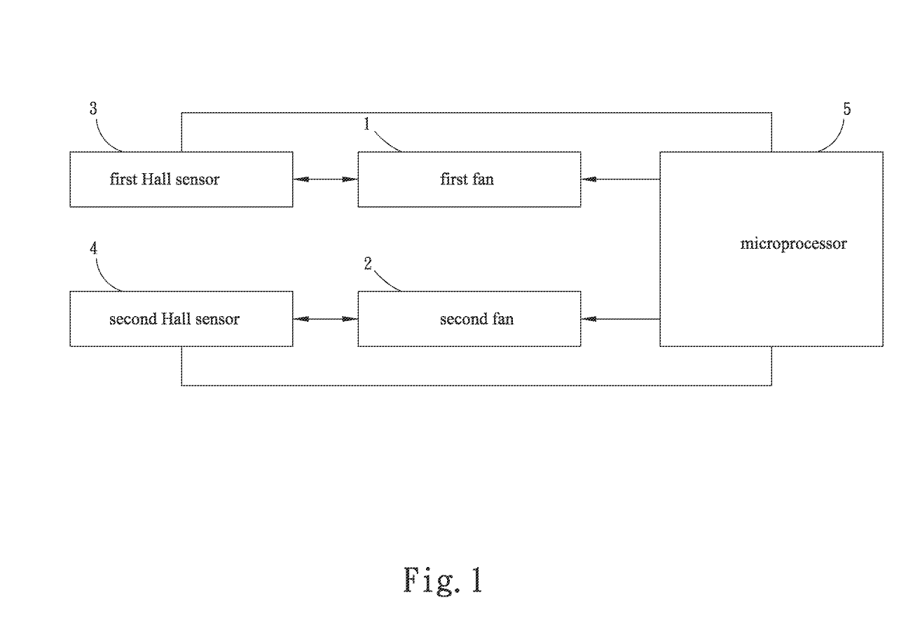

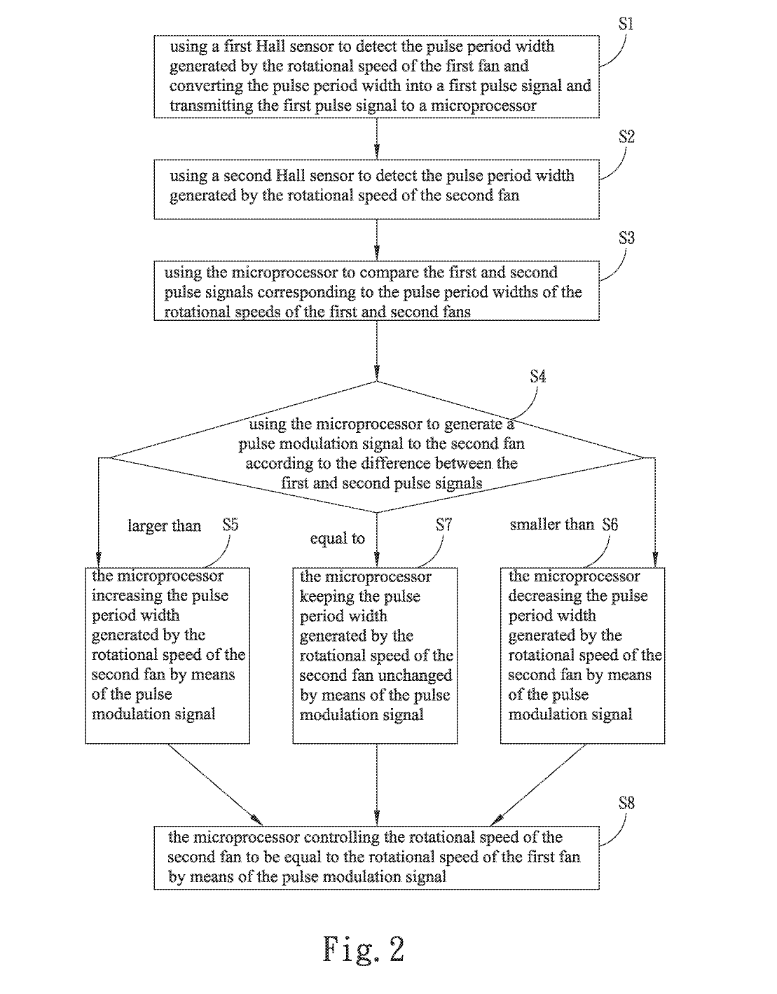

Please refer to FIGS. 1 and 2. FIG. 1 is a block diagram of a preferred embodiment of the present invention. FIG. 2 is a flow chart of a preferred embodiment of the present invention. The synchronizing method of fan rotational speed of the present invention is applied to a first fan 1 and a second fan 2 mated with each other. The synchronizing method of fan rotational speed of the present invention includes steps of:

S1. using a first Hall sensor to detect the pulse period width generated by the rotational speed of the first fan and converting the pulse period width into a first pulse signal and transmitting the first pulse signal to a microprocessor, in operation of the first fan 1, the stator assembly of the first fan 1 generating a pulse period, according to the state of the rotational speed of the first fan 1, the pulse period generating different pulse period widths, the first Hall sensor 3 detecting the pulse period width generated by the rotational speed of the first fan and converting the pulse period width into a first pulse signal and transmitting the first pulse signal to a microprocessor 5;

S2. using a second Hall sensor to detect the pulse period width generated by the rotational speed of the second fan, in operation of the second fan 2, the stator assembly of the second fan 2 generating a pulse period, according to the state of the rotational speed of the second fan 2, the pulse period generating different pulse period widths, the second Hall sensor 4 detecting the pulse period width generated by the rotational speed of the second fan and converting the pulse period width into a second pulse signal and transmitting the second pulse signal to the microprocessor 5;

S3. using the microprocessor to compare the first and second pulse signals corresponding to the pulse period widths of the rotational speeds of the first and second fans, the microprocessor 5 receiving the first and second pulse signals from the first and second Hall sensors 3, 4 and comparing the first and second pulse signals corresponding to the pulse period widths of the rotational speeds of the first and second fans;

S4. using the microprocessor to generate a pulse modulation signal to the second fan according to the difference between the first and second pulse signals, according to the difference between the first and second pulse signals, the microprocessor 5 generating a pulse modulation signal and transmitting the pulse modulation signal to the second fan 2, in case the first pulse signal is larger than the second pulse signal, the procedure going to step S5, in case the first pulse signal is smaller than the second pulse signal, the procedure going to step S6, in case the first pulse signal is equal to the second pulse signal, the procedure going to step S7;

S5. the microprocessor increasing the pulse period width generated by the rotational speed of the second fan by means of the pulse modulation signal, the microprocessor 5 comparing the first and second pulse signals, in case the pulse period width of the first pulse signal is larger than the pulse period width of the second pulse signal, the microprocessor 5 increasing the pulse period width generated by the rotational speed of the second fan by means of the pulse modulation signal so as to equalize the pulse period width generated by the rotational speed of the second fan to the pulse period width of the first pulse signal and thus control the rotational speed of the second fan to be equal to the rotational speed of the first fan;

S6. the microprocessor decreasing the pulse period width generated by the rotational speed of the second fan by means of the pulse modulation signal, in case the pulse period width of the first pulse signal is smaller than the pulse period width of the second pulse signal, the microprocessor 5 decreasing the pulse period width generated by the rotational speed of the second fan by means of the pulse modulation signal so as to equalize the pulse period width generated by the rotational speed of the second fan to the pulse period width of the first pulse signal and thus control the rotational speed of the second fan to be equal to the rotational speed of the first fan;

S7. the microprocessor keeping the pulse period width generated by the rotational speed of the second fan unchanged by means of the pulse modulation signal, in case the pulse period width of the first pulse signal is equal to the pulse period width of the second pulse signal, the microprocessor 5 keeping the pulse period width generated by the rotational speed of the second fan unchanged by means of the pulse modulation signal so as to keep the pulse period width generated by the rotational speed of the second fan equal to the pulse period width of the first pulse signal and thus control the rotational speed of the second fan to be equal to the rotational speed of the first fan; and

S8. the microprocessor controlling the rotational speed of the second fan to be equal to the rotational speed of the first fan by means of the pulse modulation signal, the microprocessor 5 comparing the first and second pulse signals, according to the difference between the first and second pulse signals, the microprocessor 5 generating a pulse modulation signal to the second fan and controlling the rotational speed of the second fan to be equal to the rotational speed of the first fan by means of the pulse modulation signal.

According to the above, in operation of the first and second fans 1, 2, which are mated with each other, by means of the first and second Hall sensors 3, 4 and the microprocessor 5, the first and second fans 1, 2 are controlled to synchronously operate by equal rotational speed. Under such circumstance, the problem of noise caused by difference between the rotational speeds of the fans can be eliminated.

In conclusion, in comparison with the prior art, the present invention has the following advantages:

1. The fans can synchronously operate by equal rotational speed.

2. The problem of noise caused by difference between the rotational speeds of the fans is eliminated.

3. The operation efficiency of the fans is enhanced.

The present invention has been described with the above embodiments thereof and it is understood that many changes and modifications in the above embodiments can be carried out without departing from the scope and the spirit of the invention that is intended to be limited only by the appended claims.

What is claimed is:

1. A synchronizing method of fan rotational speed applied to a first fan and a second fan mated with each other, the synchronizing method of fan rotational speed comprising steps of:
using a first Hall sensor to detect pulse period width generated by the rotational speed of the first fan and converting the pulse period width into a first pulse signal and transmitting the first pulse signal to a microprocessor;
using a second Hall sensor to detect pulse period width generated by the rotational speed of the second fan and converting the pulse period width into a second pulse signal and transmitting the second pulse signal to the microprocessor;
using the microprocessor to compare the first and second pulse signals corresponding to the pulse period widths of the rotational speeds of the first and second fans;
using the microprocessor to generate a pulse modulation signal to the second fan according to the difference between the first and second pulse signals; and
the microprocessor controlling the rotational speed of the second fan to be equal to the rotational speed of the first fan by means of the pulse modulation signal.

2. The synchronizing method of fan rotational speed as claimed in claim 1, wherein in case the first pulse signal is larger than the second pulse signal, the microprocessor increases the pulse period width generated by the rotational speed of the second fan by means of the pulse modulation signal.

3. The synchronizing method of fan rotational speed as claimed in claim 1, wherein in case the first pulse signal is smaller than the second pulse signal, the microprocessor decreases the pulse period width generated by the rotational speed of the second fan by means of the pulse modulation signal.

4. The synchronizing method of fan rotational speed as claimed in claim 1, wherein in case the first pulse signal is equal to the second pulse signal, the microprocessor keeps the pulse period width generated by the rotational speed of the second fan unchanged by means of the pulse modulation signal.
